(19) United States
(12) Patent Application Publication
(10) Pub. No.: US 2026/0233157 A1
(43) Pub. Date: Aug. 13, 2026

(54) METHOD AND SYSTEM FOR REDUCING EMISSIONS IN HYDROGEN PRODUCTION

(71) Applicant: Chevron U.S.A. Inc., San Ramon, CA (US)

(72) Inventors: Daniel Chinn, Danville, CA (US); Zihan Huang, Moraga, CA (US); Nitesh Bhuwania, Richmond, CA (US)

(21) Appl. No.: 19/536,869

(22) Filed: Feb. 11, 2026

Related U.S. Application Data
(60) Provisional application No. 63/757,127, filed on Feb. 11, 2025.

(51) Int. Cl. B01D 53/22; B01D 53/62; C01B 3/16; C01B 3/34; C01B 3/48

(52) U.S. Cl. CPC B01D 53/228; B01D 53/22; B01D 53/229; B01D 53/62; C01B 3/16; C01B 3/34; C01B 3/48; C01B 2203/0233; C01B 2203/0405; C01B 2203/043

(57) ABSTRACT

A method of reducing emissions associated with hydrogen (H₂) production includes producing a syngas stream comprising H₂, CO, CO₂, H₂O, and unreacted CH₄ using a steam methane reformer (SMR). A water-gas shift (WGS) process reacts residual H₂O in the syngas stream with CO to form additional H₂ and CO₂ and thereby produce a shifted syngas stream having less H₂O, more H₂, and more CO₂ than the syngas stream. The shifted syngas stream is provided to a first facilitated transport membrane (FTM), such that CO₂ of the shifted syngas stream permeates across the first FTM to produce a first CO₂ stream at a permeate side of the first FTM and a CO₂-depleted shifted syngas stream at a retentate side of the first FTM. A second gas separation process removes H₂ from the CO₂-depleted shifted syngas to produce an H₂ product stream and a tail gas stream.

### FIELD

The present disclosure relates to the use of membrane-based separation to separate carbon dioxide (CO₂) from hydrogen during hydrogen production.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Most large-scale hydrogen production is done by reaction of natural gas and steam by the steam methane reforming (SMR) process. The SMR reaction is highly endothermic, so energy to drive the reaction is achieved by burning a mixture of natural gas and unreacted tail gas in a SMR furnace that is integrated with packed SMR catalyst tubes. Thus, production of hydrogen by SMR results in significant CO₂ production and potential emissions.

As shown in FIG. 1, a system 10 having a typical SMR 12 (with catalyst tubes 12a and a furnace section 12b) produces a syngas 14 at high temperatures (e.g., 850° C.) and pressures (e.g., 28 bar) with the components H₂, CO, CO₂, H₂O, and unreacted CH4. After heat recovery to generate process stream, the syngas 14 is often cooled down (e.g., using one or more heat exchangers 16) to an intermediate temperature and sent through one or more water gas shift (WGS) reactors that could be high-temperature (HTWGS 18, e.g., 300° C.) or low temperature (LTWGS 20, e.g., 200° C.), or both. As an example, a first heat exchanger 16a may cool the syngas 14 to 288° C. at a pressure of 27.5 bar. In this example, the HTWGS 18 produces a first shifted syngas 19 having a temperature of 370° C. and a pressure of 24.8 bar. A second heat exchanger 16b cools the first shifted syngas 19 to a temperature of 200° C. and a pressure of 24.4 bar. The LTWGS 20 produces a shifted syngas 22 having a temperature of 217° C. and a pressure of 24.1 bar. The purpose of the WGS reactions is to allow for the residual water in the syngas to react with CO to form more H₂ and CO₂ to produce the shifted syngas 22.

As the temperature of the shifted syngas 22 is too high for typical gas separation processes, the shifted syngas is cooled using heat exchanger 24 to 35° C. to 40° C. After knocking out 26 the condensed water from cooling, the cooled shifted syngas 28 (e.g., 40° C., 23.7 bar, 74% H₂, 19% CO₂, 6.5% C₁) is sent to a pressure swing adsorption (PSA) process 30 which recovers 80% to 92% of the feed H₂ as a high-pressure, highly pure (99.9+%) H₂ product stream having for example a temperature of 35° C. and a pressure of 23.7 bar. A low-pressure tail gas 32 (e.g., 40° C., 1.3 bar, 24% H₂, 54% CO₂, 19% C₁) results from purging, depressurization, and blowdown of the beds during pressure swing. This tail gas 32 may contain H₂, CO, CO₂, and unreacted CH4 and is almost always used as the main fuel source for the SMR furnace 12a. FIG. 2 depicts the various flows of FIG. 1 with example flow rates, pressures, gas makeups, and temperatures.

To lower the carbon generated in a hydrogen production process, existing approaches include adding an amine absorber and regenerator to process the SMR flue gas, one or two-stage membranes on the SMR flue gas, an amine process or physical solvent (e.g., Selexol) applied on the syngas stream, upstream of the PSA, or some combination of these. The principal disadvantages of many of these approaches is that they require low temperature operation. In the case of amines, significant amounts of low-pressure steam and the infrastructure to handle it would be required, along with storage tanks for solvents and large heat exchangers, packed columns, and pumps for handling the solvent as it absorbs and desorbs the CO₂.

Despite these existing approaches, there remains a need to reduce the carbon intensity associated with hydrogen production using SMR technologies in a more cost- and energy-efficient manner. In particular, there remains a need to lower the carbon intensity in a manner that does not require significant amounts of infrastructure, energy for steam generation, or the use of large amounts of solvents.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of this disclosure generally relate to the use of facilitated transport membranes (FTMs) to capture CO₂ produced during the SMR-based production of hydrogen. In accordance with an embodiment, for example, a method of reducing emissions associated with hydrogen (H₂) production may include in a steam methane reformer (SMR), reacting steam and natural gas to produce a syngas stream comprising H₂, CO, CO₂, H₂O, and unreacted CH4. A water-gas shift process reacts residual H₂O in the syngas stream with CO to form additional H₂ and CO₂ and thereby produce a shifted syngas stream, the shifted syngas stream having less H₂O, more H₂, and more CO₂ than the syngas stream. A first gas separation process in which the shifted syngas stream is provided to an inlet of a first membrane separation module, the first membrane separation module comprising a first facilitated transport membrane (FTM), such that CO₂ of the shifted syngas stream permeates across the first FTM to produce a first CO₂ stream at a permeate side of the first FTM and a CO₂-depleted shifted syngas stream at a retentate side of the first FTM. The first FTM has a composition that allows H₂O to facilitate selective permeation of CO₂ over other components of the shifted syngas stream. A second gas separation process in which H₂ is removed from the CO₂-depleted shifted syngas produces an H₂ product stream and a tail gas stream used for combustion in a furnace section of the SMR.

In accordance with another embodiment, a system for producing low carbon hydrogen (H₂) includes a steam methane reformer (SMR) configured to produce a syngas stream from natural gas and steam, the syngas stream comprising H₂, CO, CO₂, H₂O, and unreacted CH4. A water-gas shift reaction system is configured to receive the syngas stream and to perform a water-gas shift process to react residual H₂O in the syngas stream with CO to form additional H₂ and CO₂ and thereby produce a shifted syngas stream. The shifted syngas stream has less H₂O, more H₂, and more CO₂ than the syngas stream. A first membrane separation module is configured to receive the shifted syngas stream at an inlet, the first membrane separation module comprising a first facilitated transport membrane (FTM), wherein the first FTM has a composition that facilitates selective permeation of CO₂ from a retentate side to a permeate side of the first FTM over other components of the shifted syngas stream at the humidity level of the shifted syngas stream such that the first membrane separation module is configured to produce a CO₂-depleted shifted syngas stream at the retentate side and a first CO₂ product stream at the permeate side. A CO₂ product flow path is configured to flow CO₂ from the permeate side of the first FTM. A gas separation unit is configured to receive the CO₂-depleted shifted syngas stream and to separate H₂ from other components of the CO₂-depleted shifted syngas stream to produce an H₂ product stream and a tail gas stream.

### BRIEF DESCRIPTION OF THE DRAWINGS

Various embodiments of the present disclosure, together with further objects and advantages, may best be understood by reference to the following description taken in conjunction with the accompanying drawings, wherein:

FIG. 1 is a process flow diagram of a typical steam methane reforming (SMR)-based hydrogen production process;

FIG. 2 depicts the various flows of FIG. 1 with example flow rates, pressures, gas makeups, and temperatures;

FIG. 3 is a process flow diagram of an embodiment of a system that uses dual facilitated transport membranes in an SMR-based hydrogen production process to reduce the carbon intensity of the process;

FIG. 4 depicts the various flows of FIG. 3 with example flow rates, pressures, gas makeups, and temperatures;

FIG. 5 is a process flow diagram of an embodiment of a compression, intercooling, and water knockout system used in combination with the dual FTM configuration of FIG. 2; and

FIG. 6 depicts the various flows of FIG. 5 with example flow rates, pressures, gas makeups, and temperatures.

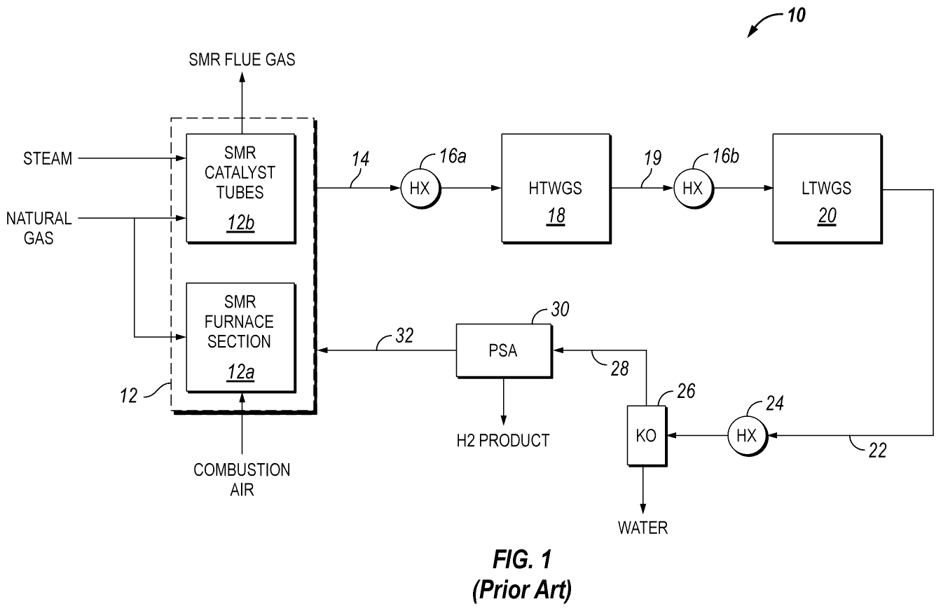

### DETAILED DESCRIPTION

The terms exhaust gas, exhaust flue gas, and flue gas are used interchangeably herein. As set forth above, there is a need to lower the carbon intensity associated with SMR-based hydrogen production in a cost- and energy-efficient manner. It is presently recognized that the use of dual facilitated transport membranes within such hydrogen production processes may address this and other needs.

Embodiments of this disclosure take advantage of the unusual properties of certain facilitated transport membranes (FTM) to effectively separate CO₂ from H₂ at high pressures and CO₂ from N₂ at low pressures at elevated temperatures and humid conditions. FTMs may have functional groups (e.g., amine groups) that form weak, reversible bonds with CO₂ which would help accelerate transport across the membranes, beyond what is typical for the solution-diffusion mechanism for gas in polymeric membranes. Facilitated transport membranes also often require the presence of water to function properly. By way of non-limiting example, FTMs that may be used in certain embodiments include those described in U.S. Patent Application Publication No. 2023/0182089, which is incorporated by reference herein for all purposes.

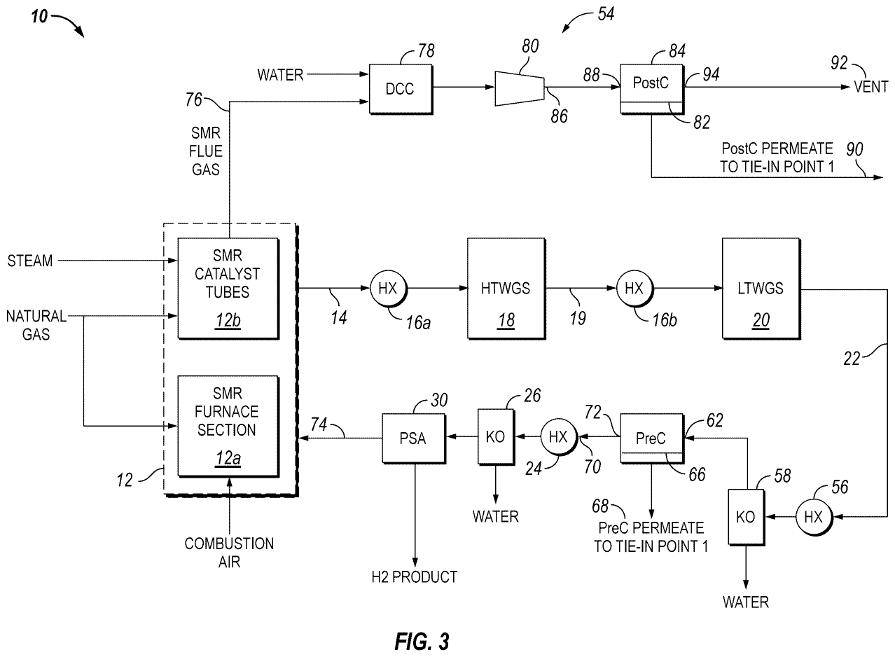

In accordance with certain embodiments of this disclosure, a dual membrane configuration is used. In such embodiments, one membrane is placed on the shifted syngas stream to do bulk removal of CO₂ from syngas, while another membrane is placed on the SMR flue gas to remove CO₂ prior to venting. This may be further appreciated with reference to FIG. 3.

FIG. 3 depicts an example embodiment of a hydrogen production system 50 having integrated membrane separation. Specifically, in this embodiment the system 50 includes a pre-combustion membrane separation assembly 52 and a post-combustion membrane separation assembly 54. The terms “pre-combustion” and “post-combustion” are intended to refer to the position of the membrane separation assemblies relative to the combustion that occurs within the SMR furnace section 12a.

As depicted in FIG. 3, the pre-combustion membrane separation assembly 52 includes a heat exchanger 56 and water knockout 58 to cool the shifted syngas stream 22 (e.g., from 217° C. at 24.1 bar to 120° C. at 23.7 bar) to between 120 and 130° C. The cooled shifted syngas stream 22 is sent to an inlet 62 of a first membrane module 64, which includes a first facilitated transport membrane (FTM) 66 (a pre-combustion membrane). The first FTM 66 has a perm-selectivity for CO₂ over other gaseous components of the shifted syngas stream 22. This perm-selectivity is enhanced by H₂O, such as the H₂O present within the shifted syngas stream 22. In this regard, in some embodiments the water knockout 58 performed upstream of the first FTM 66 may leave sufficient H₂O in the shifted syngas stream 22 to facilitate CO₂ transport across the first FTM 66. In other embodiments, no water knockout 58 may be performed, and in still further embodiments, H₂O may be added to the shifted syngas stream 22 to facilitate CO₂ transport across the first FTM 66. In accordance with present embodiments, the feed pressure of the first FTM 66 (pre-combustion membrane) is kept to within a certain range of the pressure of the syngas stream after the final water gas shift reaction, with only a slight pressure drop due to cooling of the stream. For instance, the feed pressure of the shifted syngas stream 22 into the first membrane module 66 may be within 90% and 99% of the pressure of the shifted syngas stream 22 exiting the final WGS reactor (in the depicted embodiment, downstream of the LTWGS 20).

Accordingly, during operation H₂O-assisted permeation of CO₂ of the cooled shifted syngas stream 22 across the first FTM 66 produces a first CO₂ stream (e.g., a pre-combustion permeate) 68. A CO₂-depleted shifted syngas 70 is thus left at a retentate side 72 of the first FTM 66, and is provided as an input to the heat exchanger 24, water knockout 26, and subsequently the PSA 30 to generate a CO₂-depleted tail gas 74. The CO₂-depleted tail gas 74 is provided to the SMR furnace section 12a as its main fuel source.

Turning now to the SMR 12, an SMR flue gas 76 is produced from the SMR furnace section 12a. As shown in the embodiment of FIG. 3, the post-combustion membrane separation assembly 54 includes a direct contact cooler (DCC) 78, which directly contacts the SMR flue gas 76 with water primarily to humidify the SMR flue gas 76 for facilitated transport. The DCC 78 also cools the SMR flue gas 76 to a temperature that allows compression via compressor 80 to create a pressure difference across a second FTM 82 (a post-combustion membrane) of a second membrane module 84. The cooling and compression upstream of the second membrane module 84 is beneficial because the SMR flue gas 76 is at 1 bar and has a relatively low humidity, which may be insufficient for membrane-based separation. The feed pressure of the second membrane module 84 may vary from 1.1 to 2.0 bar. 2.0 bar is a convenient upper limit for a single-stage compressor with a discharge temperature of under 160° C., which is generally an upper limit for separation using FTMs.

In the post-combustion membrane separation assembly 54, the compressor 80 outputs a humidified and pressurized SMR flue gas stream 86 to an inlet 88 of the second membrane module 84. The second FTM 82 has a perm-selectivity for CO₂ over other gaseous components of the humidified and pressurized SMR flue gas stream 86. This perm-selectivity is enhanced by the H₂O present, as discussed with respect to the first FTM 66.

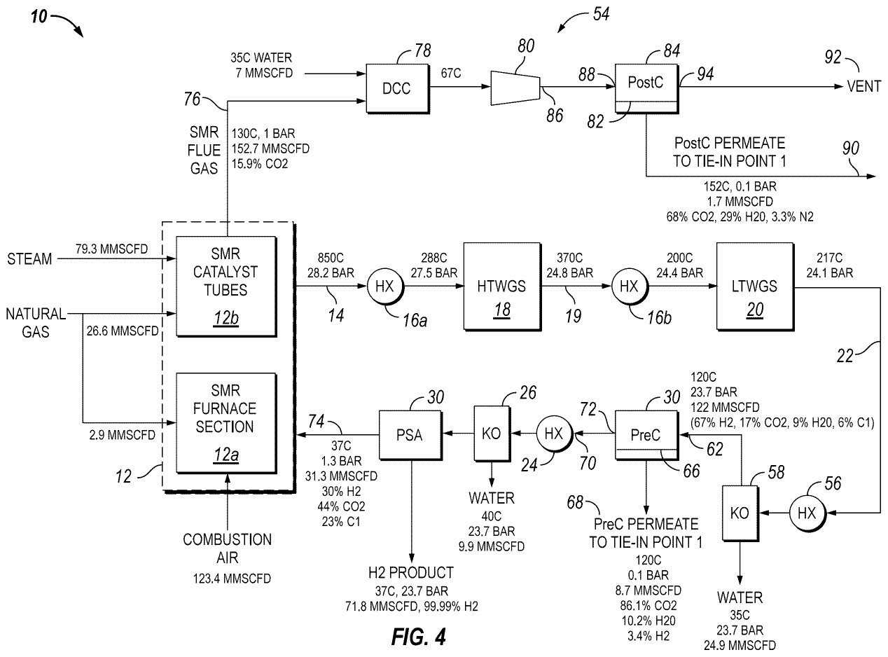

During operation H₂O-assisted permeation of CO₂ of the humidified and pressurized SMR flue gas stream 86 across the second FTM 82 produces a second CO₂ stream (e.g., a post-combustion permeate) 90. A CO₂-depleted flue gas 92 is thus left at a retentate side 94 of the second FTM 82, and may be vented. FIG. 4 depicts the various flows of FIG. 3 with example flow rates, pressures, gas makeups, and temperatures.

Regarding the first FTM 66 and the second FTM 82, single-stage membranes may be used for both, since given the high selectivity of FTMs one would try to remove as much CO₂ as possible without compromising loss of hydrogen (pre-combustion membrane 66) or excessive co-permeation of nitrogen or other flue gas components (post-combustion membrane 82).

In addition, the permeate pressure will be set as low as practically possible, e.g., 0.1 bar for both membranes (first FTM 66 and second FTM 82). A back pressure regulator or pressure control valve positioned on the permeate side of the membranes may be used to control the pressure to a pre-determined value.

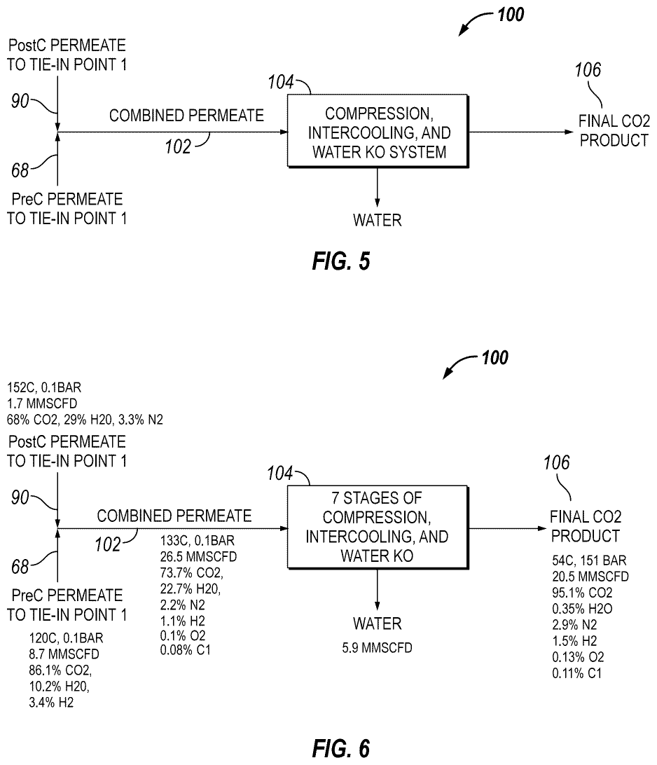

FIG. 5 is a process flow diagram of a processing system 100 for processing the permeate streams from both membrane modules. As shown in FIG. 5, the permeate streams from both membranes (pre-combustion permeate 68 and post-combustion permeate 90) may be mixed to produce a combined permeate 102. The combined permeate is sent to a common compression, intercooling, and water knockout system 104. The compression, intercooling, and water knockout system 104 produces a final CO₂ product, which may in some embodiments be above 90% pure (e.g., between 90% and 99% pure, such as 95% pure) with a pressure of between 130 bar and 160 bar, such as between 150 and 155 bar, for example at 151 bar. The high-purity CO₂ product may be further transported for eventual sequestration, reacted in some carbon utilization process, used for enhanced oil recovery, or further purified to make food-grade CO₂. Example mass flow rates, gas compositions, pressures and temperatures for these flows are shown in FIG. 6.

Table 1 summarizes some of the benefits of the embodiments of the invention (FIGS. 3-6) in terms of producing the same amount of hydrogen with a net lower carbon emissions. At a post-combustion feed pressure of 1.1 bar, the SMR process would generate 5.45 lb CO₂/lb H₂ while at 2 bar feed, the SMR process would generate 3.72 lb CO₂/lb H₂. This is in contract to a baseline SMR plant with no carbon capture which would have 9.6 lb CO₂/lb H₂.

TABLE 1

| | | Process | Process |
|---|---|---|---|
| | | Embodiment | Embodiment |
| | | (PostComb | (PostComb |
| | Base | Mem Feed | Mem Feed |
| | Case | is 1.1 bar) | is 2.0 bar) |
| H₂ Product | 71.8 | 71.8 | 71.8 |
| (MMSCFD), 99.99% | | | |
| CO₂ Product | 0 | 14.5 | 20.5 |
| (MMSCFD), 95% | | | |
| NG Feed to SMR | 26.5 | 26.6 | 26.6 |
| (MMSCFD) | | | |
| Steam Feed to SMR | 77.5 | 77.8 | 77.8 |
| (MMSCFD) | | | |
| NG Fuel (MMSCFD) | 2.9 | 2.9 | 2.9 |
| Incremental Power | 0 | 6870 | 14,940 |
| (kw) | | | |
| Direct CO₂ Emissions | 152,963 | 86,703 | 59,204 |
| from SMR (lb/hr) | | | |
| Indirect CO₂ Emissions | 0 | 6,045 | 13,200 |
| from Power (lb/hr) | | | |
| Total CO₂ Emissions | 1669 | 1012 | 789 |
| (tonne/day) | | | |
| lb CO₂ emitted/lb H₂ | 9.61 | 5.45 | 3.72 |
| PreComb Membrane | 0 | 2477 | 3097 |
| Area (m2) | | | |
| PostComb Membrane | 0 | 10,320 | 8258 |
| Area (m2) | | | |

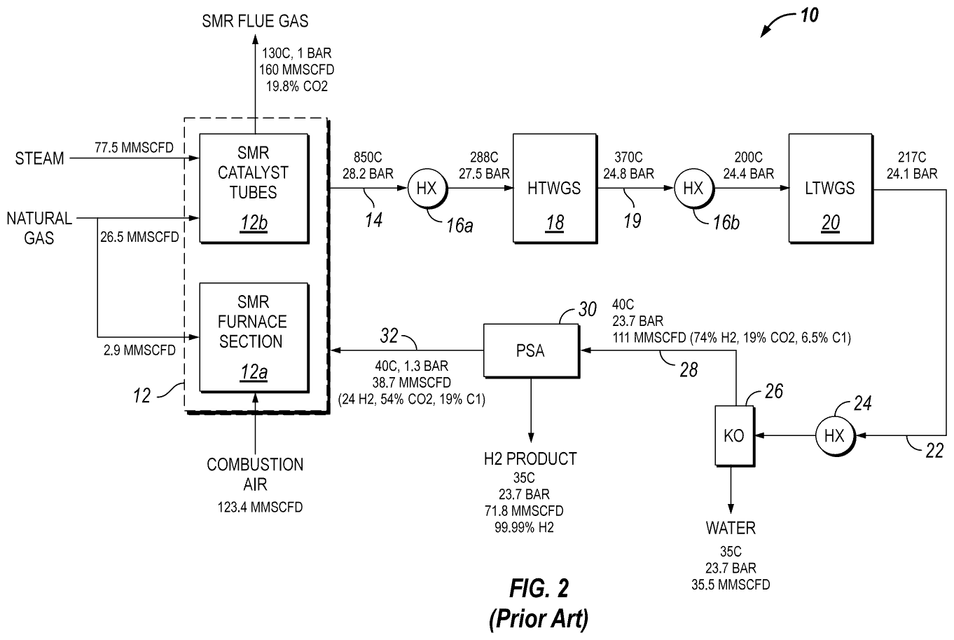

Table 2 shows an example set of properties of FTMs used in modeling the examples (FIGS. 2, 4, 6) in this disclosure. The same membrane has a CO₂/H₂ selectivity of 125 and CO₂ permeance of 300 GPU at elevated temperatures and pressures. At atmospheric pressure the FTM has a CO₂/N₂ selectivity of 125 and CO₂ permeance of 3500 GPU. To exploit these membranes, it is desirable to design a system with a maximum pressure ratio between the feed and permeate, while achieving some final CO₂ purity (e.g., 95 vol %).

TABLE 2

| | PreComb | PostComb |
|---|---|---|
| Type | Spiral | Spiral |
| Preferred Feed Temp (deg C.) | 120 | 120 to 150 |
| Preferred Feed Pressure (kpa) | 2480 | 110 to 200 |
| Preferred Permeate Pressure (kpa) | 10 | 10 |
| CO₂ Permeance (GPU) | 300 | 3500 |
| H₂O Permeance (GPU) | 60 | 600 |
| N₂ Permeance (GPU) | 2 | 23 |
| O₂ Permeance (GPU) | 20 | 200 |
| SO₂ Permeance (GPU) | 300 | 3500 |
| Ar Permeance (GPU) | 2 | 5 |
| H₂ Permeance (GPU) | 2.4 | 28 |
| CO Permeance (GPU) | 2 | 5 |
| Sheet Width (m) | 2.54E−03 | 2.54E−03 |
| Heat Transfer Coefficient (kJ/m²*hr*deg C.) | 0.1 | 0.1 |
| Bundle OD (m) | 0.2032 | 0.2032 |
| Bundle ID (m) | 2.54E−02 | 2.54E−02 |
| Membrane Count (Sheet/Fibers) | 4000 | 4000 |
| Membrane Active Length (m) | 1.016 | 1.016 |
| Membrane Inner Pot Length (m) | 0.1016 | 0.1016 |
| Membrane Outer Pot Length (m) | 0.1016 | 0.1016 |
| Sheet Internal Spacer Thickness (m) | 1.27E−02 | 1.27E−02 |
| Sheet External Spacer Thickness (m) | 1.27E−02 | 1.27E−02 |
| Total Area per Bundle (m) | 20.65 | 20.65 |

The specific embodiments described above have been shown by way of example, and it should be understood that these embodiments may be susceptible to various modifications and alternative forms, and can also be used in any appropriate combination. It should be further understood that the claims are not intended to be limited to the particular forms disclosed, but rather to cover all modifications, equivalents, and alternatives falling within the spirit and scope of this disclosure.

What is claimed is:

1. A method of reducing emissions associated with hydrogen (H₂) production, comprising:
in a steam methane reformer (SMR), reacting steam and natural gas to produce a syngas stream comprising H₂, CO, CO₂, H₂O, and unreacted CH₄;
performing a water-gas shift process to react residual H₂O in the syngas stream with CO to form additional H₂ and CO₂ and thereby produce a shifted syngas stream, the shifted syngas stream having less H₂O, more H₂, and more CO₂ than the syngas stream;
performing a first gas separation process in which the shifted syngas stream is provided to an inlet of a first membrane separation module, the first membrane separation module comprising a first facilitated transport membrane (FTM), such that CO₂ of the shifted syngas stream permeates across the first FTM to produce a first CO₂ stream at a permeate side of the first FTM and a CO₂-depleted shifted syngas stream at a retentate side of the first FTM, wherein the first FTM has a composition that allows H₂O to facilitate selective permeation of CO₂ over other components of the shifted syngas stream; and
performing a second gas separation process in which H₂ is removed from the CO₂-depleted shifted syngas to produce an H₂ product stream and a tail gas stream used for combustion in a furnace section of the SMR.

2. The method of claim 1, comprising:
combusting the tail gas stream and a stream of combustion air in the furnace section of the SMR to produce an SMR flue gas stream, the combustion providing heat to drive the reaction between the steam and natural gas in the SMR; and
performing a third gas separation process in which the SMR flue gas stream is provided to an inlet of a second membrane separation module, the second membrane separation module comprising a second FTM, to produce a second CO₂ stream at a permeate side of the second FTM and a CO₂-depleted SMR flue gas stream.

3. The method of claim 2, comprising combining the first CO₂ stream and the second CO₂ stream to produce a combined CO₂ stream, and processing the combined CO₂ stream to produce a CO₂ product stream.

4. The method of claim 3, wherein processing the combined CO₂ stream comprises directing the combined CO₂ stream to a series of compression, intercooling, and water knockout stages.

5. The method of claim 2, wherein the permeate side of the second FTM is set to a pressure that is between 1% and 10% of a pressure of the SMR flue gas stream at the inlet of the second membrane separation module to discourage co-permeation of flue gas components other than CO₂ across the second FTM

6. The method of claim 2, comprising humidifying the SMR flue gas stream via direct contact cooling before providing the SMR flue gas stream to the second membrane module to allow the added H₂O to facilitate transport of the CO₂ across the second FTM.

7. The method of claim 1, wherein a temperature of the shifted syngas stream generated at an outlet of the water-gas shift process is reduced to a lower temperature of 50° C. to 130° C. to the inlet of the first membrane separation module.

8. The method of claim 1, wherein the permeate side of the first FTM is set to a pressure that is between 1% and 10% of a pressure of the shifted syngas stream at the inlet of the first membrane separation module to discourage co-permeation of H₂ across the first FTM.

9. The method of claim 1, wherein performing the water-gas shift process comprises:
reacting, in a first water-gas shift reactor, residual H₂O in the syngas stream with CO to form additional H₂ and CO₂ to produce a first shifted syngas stream; and
reacting, in a second water-gas shift reactor, residual H₂O in the first shifted syngas stream with CO to form additional H₂ and CO₂ to produce a second shifted syngas stream; and
wherein the first water-gas shift reactor is operated at a higher temperature and pressure than the second water-gas shift reactor.

10. The method of claim 8, wherein the second shifted syngas stream is the shifted syngas stream that is output by the water-gas shift process.

11. The method of claim 1, wherein the second gas separation process comprises a pressure swing adsorption (PSA) process.

12. A system for producing low carbon hydrogen (H₂), comprising:
a steam methane reformer (SMR) configured to produce a syngas stream from natural gas and steam, the syngas stream comprising H₂, CO, CO₂, H₂O, and unreacted CH₄;
a water-gas shift reaction system configured to receive the syngas stream a and to perform a water-gas shift process to react residual H₂O in the syngas stream with CO to form additional H₂ and CO₂ and thereby produce a shifted syngas stream, the shifted syngas stream having less H₂O, more H₂, and more CO₂ than the syngas stream;
a first membrane separation module configured to receive the shifted syngas stream at an inlet, the first membrane separation module comprising a first facilitated transport membrane (FTM), wherein the first FTM has a composition that facilitates selective permeation of CO₂ from a retentate side to a permeate side of the first FTM over other components of the shifted syngas stream at the humidity level of the shifted syngas stream such that the first membrane separation module is configured to produce a CO₂-depleted shifted syngas stream at the retentate side and a first CO₂ product stream at the permeate side;
a CO₂ product flow path configured to flow CO₂ from the permeate side of the first FTM; and
a gas separation unit configured to receive the CO₂-depleted shifted syngas stream and to separate H₂ from other components of the CO₂-depleted shifted syngas stream to produce an H₂ product stream and a tail gas stream.

13. The system of claim 12, comprising:
a furnace section of the SMR configured to receive and combust the tail gas stream and a stream of combustion air to produce an SMR flue gas and heat that is used to drive the reaction between the steam and natural gas in the SMR; and
a second membrane separation module configured to receive the SMR flue gas stream at an inlet, the second membrane separation module comprising a second FTM, wherein the second FTM has a composition that facilitates selective permeation of CO₂ from a retentate side to a permeate side of the second FTM over other components of the SMR flue gas stream at the humidity level of the SMR flue gas stream such that the second membrane separation module is configured to produce a CO₂-depleted SMR flue gas stream at the retentate side of the second FTM and a second CO₂ product stream at the permeate side of the second FTM.

14. The system of claim 13, wherein the CO₂ product flow path comprises a tie-in fluidly coupling the CO₂ flow path with the permeate side of the second FTM such that the CO₂ product flow path is configured to mix the first and second CO₂ product streams to produce a combined CO₂ stream.

15. The system of claim 14, comprising a gas processing system configured to process the combined CO₂ stream, wherein the gas processing system comprises a series of compression, intercooling, and water knockout stages.

16. The system of claim 13, wherein the permeate side of the second FTM is set to a pressure that is between 1% and 10% of a pressure of the SMR flue gas stream at the inlet of the second membrane separation module to discourage co-permeation of flue gas components other than CO₂ across the second FTM.

17. The system of claim 13, comprising a direct contact cooler configured to cool and humidify the SMR flue gas stream upstream of the second membrane module to allow the added H₂O to facilitate transport of the CO₂ across the second FTM.

18. The system of claim 12, wherein a temperature of the shifted syngas stream generated at an outlet of the water-gas shift process is reduced to a lower temperature of 50° C. to 130° C. as a feed temperature to the inlet of the first membrane separation module.

19. The system of claim 12, wherein the permeate side of the first FTM is set to a pressure that is between 1% and 10% of a pressure of the shifted syngas stream at the inlet of the first membrane separation module to discourage co-permeation of H₂ across the first FTM.
